(19) United States
(12) Patent Application Publication
(10) Pub. No.: US 2016/0347940 A1
(43) Pub. Date: Dec. 1, 2016

(54) POLYPROPYLENE RESIN COMPOSITION WITH HIGH transparency AND HEAT-RESISTANCE

(71) Applicants: HYUNDAI MOTOR COMPANY, Seoul (KR); KIA MOTORS CORPORATION, Seoul (KR); KOPLA CO., LTD., Hwaseong-si (KR)

(72) Inventors: Hyun Jun KIM, Seoul (KR); Bong Hwan OH, Hwaseong-si (KR); Jae Pil KOH, Hwaseong-Si (KR)

(21) Appl. No.: 14/957,519

(22) Filed: Dec. 2, 2015

(30) Foreign Application Priority Data
May 29, 2015 (KR) 10-2015-0075803

(51) Int. Cl. C08L 23/12

(52) U.S. Cl. CPC C08L 23/12

(57) ABSTRACT

A polypropylene resin composition having high transparency and heat-resistance comprises: 100 parts by weight of a matrix resin composition comprising 60 to 70 wt % homo-polypropylene and 30 to 40 wt % random-polypropylene; 0.3 to 0.5 parts by weight of an antioxidant; 0.3 to 0.5 parts by weight of a heat-resistance stabilizer; 0.2 to 0.5 parts by weight of a lubricant; and 0.2 to 0.5 parts by weight of a nucleating agent.

### CROSS-REFERENCE TO RELATED APPLICATION

This application claims under 35 U.S.C. §119(a) the benefit of priority to Korean Patent Application No. 10-2015-0075803 filed on May 29, 2015, the entire content of which is incorporated herein by reference.

### TECHNICAL FIELD

The present disclosure relates to a polypropylene resin composition with high transparency and heat-resistance. More particularly, the present disclosure relates to a polypropylene resin composition having high mechanical stiffness and heat-resistance as well as having improved visibility due to its high transparency.

### BACKGROUND

As a material for an engine coolant reservoir tank (also known as an “expansion tank”), block copolymer polypropylene is generally used as a resin. However, the block copolymer polypropylene resin has a disadvantage that it because although its impact performance is excellent, its mechanical strength and heat-resistance are insufficient for a high temperature and a high pressure environment. Further, the block copolymer polypropylene resin has weak visibility and transparency due to its opaque white color. Therefore, it is difficult to visually check the water level of coolant.

As an example, a high transparency polypropylene resin composition for a vehicle according to a related art comprises 30 to 74 wt % homo-polypropylene, 20 to 64 wt % ethylene-propylene random block copolymer, 5 to 30 wt % alpha-olefin copolymer, and 0.05 to 1.0 wt % of a nucleating agent. However, although this polypropylene resin composition is transparent, it has weak mechanical strength.

As another example of the related art, a propylene polymer composition comprises 30 to 50 wt % polypropylene mono-polymer and 50 to 70 wt % polypropylene-a-olefin random copolymer. However, this propylene polymer composition has weak heat-resistance.

Thus, there exists a need to improve mechanical strength and heat-resistance, of the existing materials for a use in an engine coolant reservoir tank.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with prior art.

In the present disclosure, visibility may be improved by high transparency, as well as high mechanical stiffness and high heat-resistance may be obtained, when mixing homo-polypropylene instead of using the existing block copolymer propylene for heat-resistance and high transparent random-polypropylene, and physical properties such as heat-resistance and pressure-resistance may be increased when further mixing functional additives such as an antioxidant, a heat-resistance stabilizer, a lubricant and a nucleating agent.

An aspect of the present inventive concept provides a polypropylene resin composition having improved visibility as well as high mechanical stiffness and heat-resistance.

Another aspect of the present inventive concept provides a polypropylene resin composition, with improved physical properties such as heat-resistance and pressure-resistance.

According to an exemplary embodiment of the present inventive concept, a polypropylene resin composition with high transparency and heat-resistance comprises, 100 parts by weight of a matrix resin composition comprising 60 to 70 wt % homo-polypropylene resin and 30 to 40 wt % random-polypropylene: 0.3 to 0.5 parts by weight of an antioxidant; 0.3 to 0.5 parts by weight of a heat-resistance stabilizer; 0.2 to 0.5 parts by weight of a lubricant; and 0.2 to 0.5 parts by weight of a nucleating agent.

The homo-polypropylene may have a melt index of 1 to 10 g/10 min and a softening point of 130 to 180° C.

The random-polypropylene may have a melt index of 10 to 20 g/10 min and a softening point of 100 to 160° C.

The antioxidant may be a phenol-based compound, a phosphorus compound, or a mixture thereof.

The heat-resistance stabilizer may be at least one selected from the group consisting of a sulfur-based compound, a phenol-based compound, and a phosphorous-based compound.

The lubricant may be an olefin-based compound.

The nucleating agent may be at least one selected from the group consisting of benzylidene sorbitol, methylbenzylidene sorbitol, ethylbenzylidene sorbitol, and di(p-methylbenzylidene) sorbitol.

Other aspects and exemplary embodiments are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

### DETAILED DESCRIPTION

Hereinafter reference will now be made in detail to various embodiments of the present inventive concept, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

The present disclosure provides a polypropylene resin composition with high transparency and heat-resistance comprising, 100 parts by weight of a matrix resin composition comprising: 60 to 70 wt % of a homo-polypropylene and 30 to 40 wt % of a random-polypropylene; 0.3 to 0.5 parts by weight of an antioxidant; 0.3 to 0.5 parts by weight of a heat-resistance stabilizer; 0.2 to 0.5 parts by weight of a lubricant; and 0.2 to 0.5 parts by weight of a nucleating agent.

According to the present disclosure, the homo-polypropylene is a high crystalline matrix resin having high stiffness, dimensional stability and heat-resistance. The homo-polypropylene may have a melt index of 1 to 10 g/10 min, and a softening point of 130 to 180° C. Specifically, if the melt index of the homo-polypropylene is less than 1 g/10 min, product molding may not be finished, and if it is over 10 g/10 min, a burr may be generated by over-filling when product molding.

According to the present disclosure, the random-polypropylene is a high transparent random-polypropylene resin having high impact strength and transparency. The random-polypropylene may have a melt index of 10 to 20 g/10 min, and a softening point of 100 to 160° C. Specifically, if the melt index of the random-polypropylene is less than 10 g/10 min, transparency may deteriorate due to weak miscibility with the homo-polypropylene, and if it is over 20 g/10 min, a burr may be generated by over-filling when product molding. If the content of this random-polypropylene is less than 30 wt %, transparency and impact may deteriorate, and if it is over 40 wt %, physical properties and heat-resistance may deteriorate.

According to the present disclosure, the antioxidant may be used to inhibit an oxidation degradation reaction during an extruding and injecting processing. The antioxidant may be a phenol-based compound, a phosphorus compound or a mixture thereof. Specifically, it may be tetrakis[methylene(3,5-di-tert-butyl-4-hydroxyphenyl)propionate methane], tris(2,4-di-tert-butylphenyl)phosphite, or a mixture thereof. Further, if the content of the antioxidant is less than 0.3 parts by weight, physical properties may deteriorate, and if it is over 0.5 parts by weight, external quality may be deteriorated.

According to the present disclosure, the heat-resistance stabilizer, which is used for improving long-term heat-resistance when exposed to a high temperature, may be at least one selected from the group consisting of a sulfur-based compound, a phenol-based compound, and a phosphorous-based compound. Specifically, it may be pentaerythrityl tetrakis(3-laurylthiopropionate). Further, if the content of the heat-resistance stabilizer is less than 0.3 parts by weight, heat aging-resistance may deteriorate, and if the content thereof is over 0.5 parts by weight, physical properties may deteriorate and there may be a problem of external quality.

According to the present disclosure, the lubricant, which is used for improving fluidity and releasability of the resin, may be an olefin-based compound. Specifically, the olefin-based compound may be oxidized polyethylene, ethylene bis stearamide(N,N′-Ethylene bis stearamide) or a mixture thereof. If the content of the lubricant is less than 0.2 part by weight, fluidity and releasability may deteriorate, and if it is over 0.5 part by weight, physical properties and weld strength may deteriorate.

According to the present disclosure, the nucleating agent, which is used for increasing crystallization rate of the resin to improve transparency, may be a sorbitol-based compound. Specifically, it may be at least one selected from the group consisting of benzylidene sorbitol, methylbenzylidene sorbitol, ethylbenzylidene sorbitol, and di(p-methylbenzylidene) sorbitol. In certain embodiments, it may be di(p-methylbenzylidene) sorbitol). If the content of the nucleating agent is less than 0.2 parts by weight, transparency of the resin may deteriorate, and if it is over 0.5 parts by weight, physical properties and weld strength may deteriorate.

Thus, the polypropylene resin composition according to the present disclosure may have high mechanical stiffness and heat-resistance as well as improved visibility due to high transparency, by mixing the homo-polypropylene for heat-resistance and the high transparent random-polypropylene instead of the existing block copolymer propylene.

Further, it has a benefit that it can be used as a material for a pressurized reservoir tank by increasing heat-resistance and pressure-resistance characteristics by further mixing the functional additives such as the antioxidant, the heat-resistance stabilizer, the lubricant and the nucleating agent. In particular, it has a benefit that the water level of cooling water may be checked with naked eyes due to its high transparency when it is applied to the pressurized reservoir tank.

### EXAMPLES

The following examples illustrate the invention and are not intended to limit the same.

### Examples 1 and 2 and Comparative Example 1

For Examples 1 and 2, and Comparative Example 1, ingredients as described below were prepared, and mixed at a composition ratio described in the following Table 1 to manufacture the polypropylene resin compositions having high transparency and high heat-resistance.

Ingredients:

1) Heat-Resistance Homo-Polypropylene: High crystallinity homo-polypropylene (SK Global Chemical Co., Ltd., HX3300H) having a melt index of 5 g/10 min, a softening point of 158° C., and high heat-resistance

2) High Transparent Random Polypropylene: Random polypropylene (SK Global Chemical Co., Ltd., R362Y) having a melt index of 14 g/10 min, a softening point of 135° C., impact strength and high transparency

3) Antioxidant: Phenol-based tetrakis[methylene(3,5-di-tert-butyl-4-hydroxyphenyl)propionate methane (ADEKA. AO-60), phosphorus-based tris(2,4-di-tert-butylphenyl)phosphite (SONGWON, SONGNOX 1680)

4) Heat- Resistance Stabilizer: Sulfur-based pentaerythrityl tetrakis(3-laurylthiopropionate) (ADEKA. AO-412S)

5) Lubricant: Ethylene bis stearamide (N,N′-ethylene bis stearamide) (SINWON Chemical, HI-LUBE)

6) Nucleating agent: Sorbitol-based di(p-methylbenzylidene) sorbitol (TOWREX, NU500P)

TABLE 1

| | | | | Comparative | | |
|---|---|---|---|---|---|---|
| Section | | Example | | Example | | |
| (parts by weight) | | 1 | 2 | 1 | 2 | 3 |
| Resin | Heat-Resistance | 60 | 70 | — | 55 | 75 |
| (Polypro- | Homo | | | | | |
| pylene) | High Transparency | 40 | 30 | — | 45 | 25 |
| | Random | | | | | |
| | Block Copolymer | — | — | 100 | | |
| Antioxidant | Phenol-based | 0.2 | 0.2 | — | 0.2 | 0.2 |
| | Phosphorous-based | 0.2 | 0.2 | — | 0.2 | 0.2 |

| | | | | | |
|---|---|---|---|---|---|
| Heat-Resistance Stabilizer | 0.3 | 0.3 | — | 0.3 | 0.3 |
| Lubricant | 0.2 | 0.2 | — | 0.2 | 0.2 |
| Nucleating Agent | 0.2 | 0.2 | — | 0.2 | 0.2 |

### Test Example

For the polypropylene resin compositions manufactured in Examples 1 and 2, and Comparative Examples 1 to 3, physical properties were measured by using test methods described in the following Table 2, and the results were shown as below.

TABLE 2

| | Test | | | | Comparative | | | Pressurized |
|---|---|---|---|---|---|---|---|---|
| | Method | | Example | | Example | | | Required |
| Section | (ASTM) | Unit | 1 | 2 | 1 | 2 | 3 | Level |
| Specific Gravity | D792 | — | 0.91 | 0.91 | 0.90 | 0.91 | 0.91 | |
| Tensile Strength | D638 | MPa | 34 | 38 | 24 | 28 | 40 | >25 |
| Flexural Rigidity | D790 | MPa | 43 | 45 | 34 | 31 | 48 | |
| Flexural Modulus | D790 | MPa | 1530 | 1600 | 1080 | 1300 | 1630 | >1080 |
| Impact | D256 | J/m | 65 | 57 | 61 | 70 | 32 | >44 |
| Strength(+23° C.) | | | | | | | | |
| Heat Deflection | D648 | ° C. | 135 | 137 | 105 | 120 | 138 | >135 |
| (0.45 MPa) | | | | | | | | |
| Light Transmittance | — | % | 20 | 15 | 1 | 20 | 7 | — |
| (%) | | | | | | | | |

According to the results of the above Table 2, compared to Comparative Examples 1 to 3, in Examples 1 and 2, all physical properties such as tensile strength, flexural rigidity, flexural modulus, and heat deflection improved evenly. In particular, it was found that in Comparative Example 1, light transmittance (visibility) was 1% or less, but in Examples 1 and 2, the level was significantly increased to 15 to 20%.

Further, it was found that as the level required to a pressurized reservoir tank, a burst pressure was about 3 bar in Comparative Example 1, but Examples 1 and 2 showed a high pressure-resistance of 14 bar, and a heat deflection temperature

(HDT) was improved from 105° C. (Comparative Example 1) to 135° C. (Example 1).

Further, it was found that in Comparative Example 2 using the random-polypropylene in an excessive amount of 50 wt %, a heat deflection temperature was underachieved to 120° C., and mechanical strength largely deteriorated.

Further, it was found that in Comparative Example 3 using the random-polypropylene in a small amount of 20 wt %, impact strength was underachieved to the required physical property standard, and transparency deteriorated because light transmittance was reduced to 7%.

Thus, it was confirmed that the polypropylene resin compositions manufactured in Examples 1 and 2 obtained high mechanical stiffness and heat-resistance as well as improved visibility due to its high transparency, by mixing the homo-polypropylene for heat-resistance and the high transparent random-polypropylene instead of the existing block copolymer propylene, and also it improved heat-resistance and pressure-resistance characteristics.

The polypropylene resin composition according to the present disclosure can secure excellent mechanical stiffness and heat-resistance as well as improved visibility due to its high transparency, by mixing the homo-polypropylene for heat-resistance and the high transparent random-polypropylene instead of the existing block copolymer propylene

Further, the polypropylene resin composition according to the present disclosure has a benefit that it may be used as a material for a pressurized reservoir tank by increasing heat-resistance and pressure-resistance characteristics by further mixing the functional additives such as the antioxidant, the heat-resistance stabilizer, the lubricant, and the nucleating agent.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A polypropylene resin composition having high transparency and heat-resistance comprising:
100 parts by weight of a matrix resin composition comprising 60 to 70 wt % homo-polypropylene and 30 to 40 wt % random-polypropylene;
0.3 to 0.5 parts by weight of an antioxidant;
0.3 to 0.5 parts by weight of a heat-resistance stabilizer;
0.2 to 0.5 parts by weight of a lubricant; and
0.2 to 0.5 parts by weight of a nucleating agent.

2. The polypropylene resin composition of claim 1, wherein the homo-polypropylene has a melt index of 1 to 10 g/10 min and a softening point of 130 to 180° C.

3. The polypropylene resin composition of claim 1, wherein the random-polypropylene has a melt index of 10 to 20 g/10 min and a softening point of 100 to 160° C.

4. The polypropylene resin composition of claim 1, wherein the antioxidant is a phenol-based compound, a phosphorus compound, or a mixture thereof.

5. The polypropylene resin composition of claim 1, wherein the heat-resistance stabilizer is at least one selected from the group consisting of a sulfur-based compound, a phenol-based compound, and a phosphorous-based compound.

6. The polypropylene resin composition of claim 1, wherein the lubricant is an olefin-based compound.

7. The polypropylene resin composition of claim 1, wherein the nucleating agent is at least one selected from the group consisting of benzylidene sorbitol, methylbenzylidene sorbitol, ethylbenzylidene sorbitol, and di(p-methylbenzylidene) sorbitol.
